(19) United States
(12) Patent Application Publication
(10) Pub. No.: US 2026/0077324 A1
(43) Pub. Date: Mar. 19, 2026

(54) CONTINUOUS FLOW MICROFLUIDIC SYSTEM AND METHOD FOR PRODUCING SELF-ASSEMBLED SUBSTANCE PARTICLES

(71) Applicants: Shin-Etsu Chemical Co., Ltd., Tokyo (JP); Shin-Etsu Engineering Co., Ltd., Tokyo (JP); NATIONAL UNIVERSITY CORPORATION HOKKAIDO UNIVERSITY, Sapporo-shi (JP)

(72) Inventors: Masao ANDO, Joetsu-shi (JP); Hiroyuki YAMAZAKI, Joetsu-shi (JP); Masaki TAKEUCHI, Joetsu-shi (JP); Kazuma KAWAGOE, Tokyo (JP); Masatoshi MAEKI, Sapporo-shi (JP); Manabu TOKESHI, Sapporo-shi (JP)

(73) Assignees: Shin-Etsu Chemical Co., Ltd., Tokyo (JP); Shin-Etsu Engineering Co., Ltd., Tokyo (JP); NATIONAL UNIVERSITY CORPORATION HOKKAIDO UNIVERSITY, Sapporo-shi (JP)

(21) Appl. No.: 19/330,984

(22) Filed: Sep. 17, 2025

(30) Foreign Application Priority Data
Sep. 18, 2024 (JP) 2024-160541
Nov. 8, 2024 (JP) 2024-196075

(51) Int. Cl. B01F 33/301; B01F 23/40; B01F 23/45; B01F 25/421; B01F 35/71; B01F 101/22

(52) U.S. Cl. CPC B01F 33/301; B01F 23/45; B01F 23/483; B01F 25/4231; B01F 35/7176; B01F 2101/22; B01F 2215/0431; B01F 2215/045

(57) ABSTRACT

A continuous flow microfluidic system for continuous flow operation of a microfluidic chip, in which a pulsation rate of a continuous flow formed by the system is 5% or less.

Even when a fluid sample is fed into a microfluidic chip at a high pressure, it is possible to satisfactorily and stably produce self-assembled substance particles such as lipid nanoparticles having high size uniformity, and it is possible to mass-produce such self-assembled substance particles.

### CROSS-REFERENCE TO RELATED APPLICATION

This non-provisional application claims priority under 35 U.S.C. § 119 (a) on Patent Application Nos. 2024-160541 and 2024-196075 filed in Japan on Sep. 18, 2024 and Nov. 8, 2024, respectively, the entire contents of which are hereby incorporated by reference.

### TECHNICAL FIELD

The present invention relates to a microfluidic system suitable for continuous flow operation of a microfluidic chip, and a method for producing self-assembled substance particles using the microfluidic system.

### BACKGROUND ART

Microfluidic technology is a technology capable of handling various chemical operations and biological operations such as mixing, reaction, separation, purification, culture, measurement, and detection with an extremely small amount of sample. The microfluidic technology can be utilized in various applications by providing a microfluidic chip having a flow path called a microchannel with a functional region having various functions such as a reaction region in which a reagent is disposed. Examples of utilization of the microfluidic technology include biological substance analysis, DNA inspection, drug discovery/pharmaceutical development, environmental analysis, food quality analysis, and measuring equipment.

In recent years, microfluidic technology has been rapidly spreading also in, for example, chemical synthesis such as fine particle production and organic synthesis. In particular, self-assembled substance particles such as lipid nanoparticles have recently been put into practical use as nucleic acid delivery carrier particles. For example, lipid nanoparticles have also been used as mRNA delivery carriers in a coronavirus (SARS-COV-2) mRNA vaccine that was granted emergency use permission in 2020. From such a background, attention has been focused on a method for mass production of self-assembled substance particles such as lipid nanoparticles.

Conventionally, as a method for producing self-assembled substance particles such as lipid nanoparticles, an extrusion method and an ultrasonic treatment are known, but it is difficult to produce a large amount of particles having high size uniformity by these methods.

In addition, a method for producing lipid nanoparticles utilizing microfluidic technology is also known, and according to this method, it is possible to produce particles having high size uniformity. For example, JP-A 2018-515324 (Patent Document 1) discloses a method for mass production of lipid nanoparticles by parallelization of a Dean vortex branching mixer in a system for continuous flow operation of a microfluidic chip.

### CITATION LIST

Patent Document 1: JP-A 2018-515324

### SUMMARY OF THE INVENTION

In the production of lipid nanoparticles utilizing microfluidic technology, it is desirable to continuously input a sample as a fluid at a high flow rate from the viewpoint of improving productivity. However, in a case where a sample is supplied at a high pressure in order to supply the sample to a microfluidic chip at a high flow rate, for example, in a system as described in Patent Document 1, a sample divided by a manifold is supplied to a parallelized microfluidic chip, and thus a pressure loss is large. For this reason, pulsation of the fluid cannot be sufficiently reduced, and it is difficult to produce a large amount of lipid nanoparticles having high size uniformity.

In addition, when a fluid sample is supplied to the microfluidic chip at a high pressure, there is also a concern that the microfluidic chip may be damaged. A main factor of damage to the microfluidic chip is that a high pressure fluid gives tensile stress or compressive stress to the microfluidic chip, and the stress deforms the microfluidic chip. In Patent Document 1, by parallelizing microfluidic chips, the production amount is secured while reducing the pressure applied per microfluidic chip, but since the outlets of the parallelized microfluidic chips are unified by the manifolds, it is difficult to ensure that the lipid nanoparticles manufactured by the microfluidic chips have equivalent characteristics.

The present invention has been made in view of the above circumstances, and an object thereof is to provide a continuous flow microfluidic system capable of mass-producing self-assembled substance particles such as lipid nanoparticles having high size uniformity.

As a result of intensive studies to achieve the above object, in a continuous flow microfluidic system in which a microfluidic device includes a microfluidic chip having a first supply flow path through which a first fluid flows, a second supply flow path through which a second fluid flows, and a mixing/diluting flow path that is provided on the downstream side of a junction of the first supply flow path and the second supply flow path and through which a mixed fluid of the first fluid and the second fluid flows; the first and second fluids are supplied with a continuous flow pump to the first and second supply flow paths, respectively, and mixed; and the mixed fluid is recovered through a discharge flow path connected to the downstream side of the mixing/diluting flow path, the present inventors have found that, even when a fluid sample is supplied to the microfluidic chip at a high pressure, a self-assembling substance such as lipid nanoparticles can be produced satisfactorily and stably using this system by controlling a pulsation rate of a continuous flow formed by the system to a predetermined value or less, and thus the present inventors have completed the present invention.

Therefore, the present invention provides the following continuous flow microfluidic system and method for producing self-assembled substance particles.
1. A continuous flow microfluidic system for continuous flow operation of a microfluidic chip, comprising the following (1) to (4), wherein a pulsation rate of a continuous flow formed by the system is 5% or less:
   (1) a first continuous flow pump that continuously supplies a first fluid from a first reservoir;
   (2) a second continuous flow pump that continuously supplies a second fluid from a second reservoir;
   (3) a microfluidic device including a microfluidic chip having the following flow paths (a) to (c):
   (a) a first supply flow path through which the first fluid flows;
   (b) a second supply flow path through which the second fluid flows; and
   (c) a mixing/diluting flow path that is provided on a downstream side of a junction where the first supply flow path and the second supply flow path join with each other with a certain length and through which a mixed fluid in which the first fluid and the second fluid are mixed flows; and
   (4) a discharge flow path through which the mixed fluid discharged from the microfluidic device flows.
2. The continuous flow microfluidic system according to 1, comprising a diluting portion including: a third continuous flow pump that continuously supplies a diluent solution from a third reservoir; and a diluting flow path that supplies the diluent solution discharged from the third continuous flow pump to a downstream side of the microfluidic device of the system to mix the diluent solution with the mixed fluid.
3. The continuous flow microfluidic system according to 1 or 2, comprising a waste collection flow path branched from the discharge flow path via a waste valve.
4. The continuous flow microfluidic system according to any one of 1 to 3, which has a throughput of at least 3 L/h or more per the mixing/diluting flow path.
5. The continuous flow microfluidic system according to any one of 1 to 4, wherein at least a part of the mixing/diluting flow path includes a bent flow path portion formed by a plurality of structural elements installed in the flow path, and when an axial direction of the mixing/diluting flow path is an X direction, a width direction of the mixing/diluting flow path orthogonal to the X direction is a Y direction, and a width of the mixing/diluting flow path on an upstream side of the bent flow path portion in the Y direction is [y0], the structural elements arranged to protrude from both side walls facing each other along the Y direction in the mixing/diluting flow path toward an inside of the flow path are installed alternately at predetermined intervals along the X direction, and a protrusion width of the structural elements in the Y direction is ½ [y0] or more and less than 1 [y0].
6. The continuous flow microfluidic system according to any one of 1 to 5, wherein the microfluidic chip is formed of synthetic quartz glass.
7. The continuous flow microfluidic system according to any one of 1 to 6, wherein the microfluidic device includes a chip holder and connectors,
   the chip holder includes a cover and a base that are in contact with a surface of the microfluidic chip, and a fixture that connects and fixes the cover and the base, the microfluidic chip is arranged between the cover and the base, the cover and the base are connected and fixed with the fixture, and the microfluidic chip is fixed in a state of being in close contact with the cover and the base, each connector penetrates at least one of the cover and the base, one end side is connected to an opening provided at each of an upstream end of the first supply flow path, an upstream end of the second supply flow path, and a downstream end of the mixing/diluting flow path of the microfluidic chip, and an other end side forms a supply port of the first fluid or the second fluid or a discharge port of the mixed fluid, and
   flatness of a surface of the microfluidic chip in contact with the cover and flatness of a surface of the microfluidic chip in contact with the base are both 50 μm or less, and planarity of a surface of the cover in contact with the microfluidic chip and planarity of a surface of the base in contact with the microfluidic chip are both 50 μm or less.
8. The continuous flow microfluidic system according to any one of 1 to 7, which is used for producing self-assembled substance particles, wherein in the mixing/diluting flow path, a self-assembled substance-containing solution supplied from one of the first supply flow path and the second supply flow path is diluted with a dilution medium supplied from the other flow path to form self-assembled substance particles.
9. A production method for producing self-assembled substance particles, comprising a step of diluting a self-assembled substance-containing solution with a dilution medium to obtain liquid containing self-assembled substance particles, wherein the step is performed using the continuous flow microfluidic system according to 8.
10. The production method according to 9, wherein the self-assembled substance is a lipid or an amphipathic substance.
11. The production method according to 9 or 10, wherein the dilution medium is selected from an aqueous solution, a buffer solution, a nucleic acid-containing aqueous solution, a protein-containing aqueous solution, a peptide-containing aqueous solution, an adjuvant-containing aqueous solution, and a mixed solution thereof.

### Advantageous Effects of the Invention

According to the continuous flow microfluidic system of the present invention, it is possible to satisfactorily and stably produce self-assembled substance particles such as lipid nanoparticles having high size uniformity even when a fluid sample is fed into a microfluidic chip at a high pressure, and it is possible to mass-produce such self-assembled substance particles.

### BRIEF DESCRIPTION OF THE DRAWINGS

FIG. 1 is a schematic view illustrating an example of a continuous flow microfluidic system of the present invention;

FIG. 2 is a schematic view illustrating an example of a continuous flow microfluidic system of the present invention provided with a diluting portion;

FIG. 3 is a perspective view illustrating an example of a microfluidic device constituting the continuous flow microfluidic system of the present invention;

FIG. 4 is an exploded perspective view illustrating the microfluidic device; and

FIG. 5 is a schematic view illustrating an example of a bent flow path portion provided in a microfluidic chip constituting the continuous flow microfluidic system of the present invention.

### DESCRIPTION OF THE PREFERRED EMBODIMENT

Hereinafter, the present invention is described in more detail.

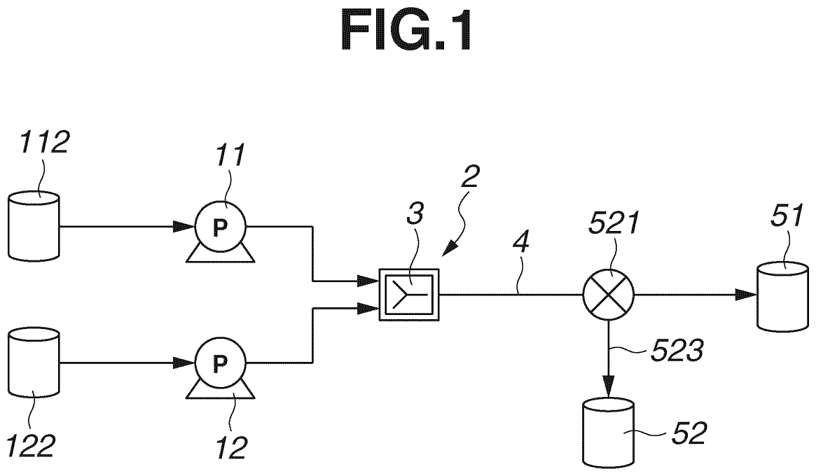

As illustrated in FIG. 1, for example, the continuous flow microfluidic system of the present invention includes a first continuous flow pump 11 that continuously supplies a first fluid, a second continuous flow pump 12 that continuously supplies a second fluid, and a microfluidic device 2 including a microfluidic chip 3.

The first continuous flow pump 11 has a suction side connected to a first reservoir 112 and a discharge side connected to the microfluidic device 2, and supplies the first fluid contained in the first reservoir 112 to the microfluidic device 2. The second continuous flow pump 12 has a suction side connected to a second reservoir 122 and a discharge side connected to the microfluidic device 2, and supplies the second fluid contained in the second reservoir 122 to the microfluidic device 2.

The first and second continuous flow pumps 11 and 12 are independent continuous flow pumps, and are not particularly limited. For example, a positive displacement pump such as a piston pump, a plunger pump, a diaphragm pump, a gear pump, a screw pump, or a vane pump, or a non-positive displacement pump such as a spiral pump, a turbine pump, an axial pump, a mixed flow pump, or a cascade pump can be used.

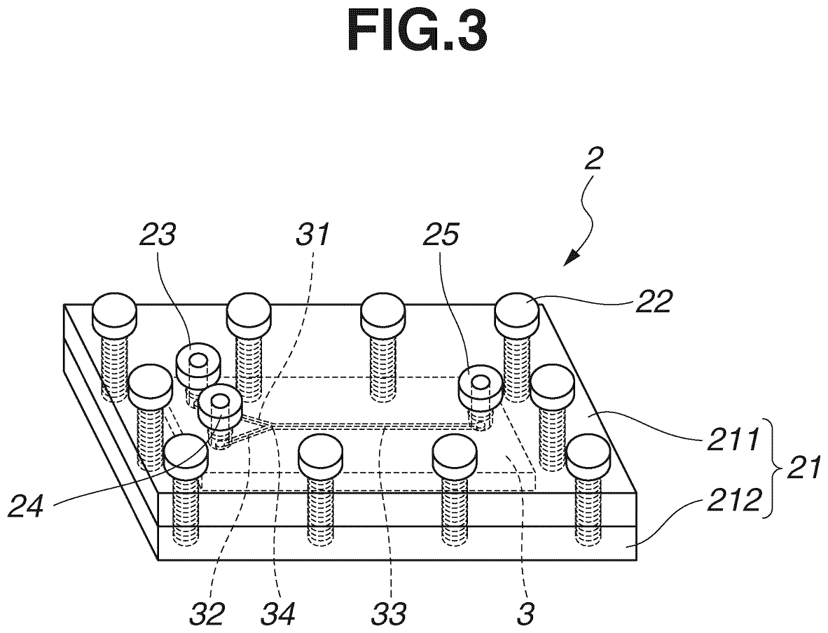

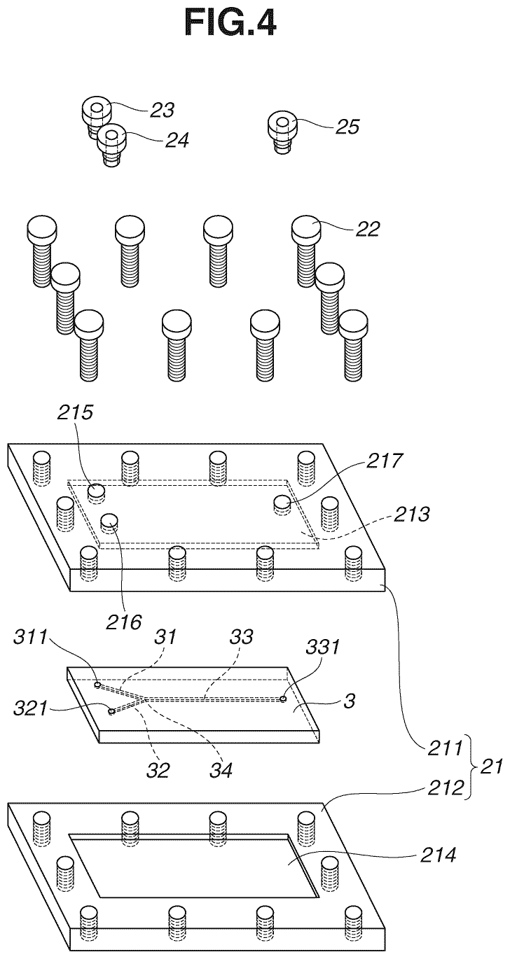

The microfluidic device 2 includes the microfluidic chip 3 as described above, and for example, as illustrated in FIGS. 3 and 4, a device having a configuration including the microfluidic chip 3 and a chip holder 21 that holds the microfluidic chip 3 inside can be exemplified.

The chip holder 21 has a structure in which a plate-shaped cover 211 and a base 212 are overlapped and fixed by a plurality of (10 in the drawing) fixtures (for example, fixing screws) 22. In addition, the cover 211 and the base 212 may be respectively provided with recesses 213, 214 for accommodating and holding the microfluidic chip 3 on inner surfaces facing each other when overlapped. Further, screw holes 215, 216, 217 opened on both outer and inner surfaces are provided in the recess 213 of the cover 211, short-shaft-bolt-shaped connectors 23, 24, 25 are screwed into the screw holes 215, 216, 217, and a flow hole opened at both ends is provided along the axis in each of the connectors 23, 24, 25.

The cover 211 and the base 212 usually have a plate shape. The shapes of the inner surfaces of the cover 211 and the base 212 in contact with the microfluidic chip 3 are preferably quadrangular shapes such as rectangular shapes, circular shapes, and the like from the viewpoint of ease of manufacturing. The inner surfaces of the cover 211 and the base 212 may have the same shape and size as the surface of the microfluidic chip 3 in contact with the cover 211 and the base 212; however, preferably have the same shape as the surface of the microfluidic chip 3 and are larger than the surface of the microfluidic chip 3. On the other hand, the thickness of each of the cover 211 and the base 212 is not particularly limited, but is preferably 1 mm or more, more preferably 3 mm or more, still more preferably 5 mm or more, and preferably 300 mm or less, more preferably 100 mm or less, still more preferably 30 mm or less. With the thickness in such a range, rigidity of the cover 211 and the base 212 can be secured, damage at the time of handling can be reduced, and the weight of the entire microfluidic device 2 can be reduced. In a case of such a plate-like shape, it is easy to withstand feeding of a sample at a high pressure and a high flow rate.

As described above, the recesses 213, 214 may be formed on surface portions of the cover 211 and the base 212 on the side facing the microfluidic chip 3. The microfluidic chip 3 can be fitted into the recesses 213, 214, and in this case, the surface of the microfluidic chip 3 and the recess 213, and the surface of the microfluidic chip 3 and the recess 214 are in contact with each other. A depth of the recesses 213, 214 is preferably 10% or more, more preferably 20% or more, and preferably 50% or less, and more preferably 45% or less of the thickness (between one surface and the other surface) of the microfluidic chip 3. The size of the recesses 213, 214 in a direction orthogonal to the depth direction is preferably larger than a size of the surface of the microfluidic chip 3 in contact with the cover 211 and the base 212 by 0.01 mm or more, more preferably 0.05 mm or more, and preferably 0.5 mm or less, and more preferably 0.1 mm or less. In this way, alignment of the microfluidic chip 3 is facilitated, and misalignment of the microfluidic chip 3 can be prevented, and thus, in particular, liquid tightness at the connector portion can be excellently maintained. In addition, it is possible to prevent damage to the microfluidic chip 3 due to excessive contact with a side surface or a peripheral surface of the recesses 213, 214 of the chip holder 21.

The cover 211 and the base 212 are each preferably formed of a metal material, a non-metal material, or a composite material of metal and non-metal. Examples of a metal material include chromium steel, stainless steel, aluminum, an aluminum alloy, titanium, and a titanium alloy, examples of a non-metal material include ceramics, and examples of a composite material of a metal and a non-metal include a fiber-reinforced metal and a fiber-reinforced plastic. Among these, stainless steel is particularly preferable from the viewpoint of case of processing, corrosion resistance, and heat resistance. In addition, the materials constituting the cover 211 and the base 212 are each preferably a material having a Young's modulus of preferably 60 GPa or more and preferably 500 GPa or less.

The fixtures 22 connect the cover 211 and the base 212, sandwich the microfluidic chip 3 between the cover 211 and the base 212, and fix the microfluidic chip 3 in close contact with the cover 211 and the base 212. The fixing method using the fixtures 22 is not particularly limited as long as the microfluidic chip 3 can be firmly attached and fixed to the cover 211 and the base 212; however, for example, mechanical fixing with fixing screws is preferable. When the cover 211 and the base 212 are fixed with screws, through holes or non-through holes may be provided in the cover 211 and the base 212, and one or both of the cover 211 and the base 212 may have screw-shaped holes. In the case of mechanical fixing with screws, the pressing force on the microfluidic chip 3 by the cover 211 and the base 212 can be adjusted throughout the microfluidic device 2 by adjusting the degree of tightening of the individual screws.

As the connectors 23, 24, 25, connectors including a screw-shaped pressing member and a ring-shaped ferrule into which a tube is inserted are preferably used. In such a connector, the ferrule can be configured to be in close contact with each of the surface of the microfluidic chip 3 and the tube by pressing from a pressing member, and with such a configuration, liquid tightness between the surface of the microfluidic chip 3 and the tube can be excellently maintained.

The pressing members of the connectors 23, 24, 25 are preferably formed of a resin material; however, may also be formed of a metal material such as stainless steel. Examples of the resin material include PEEK, PPS, POM, PE, PP, ETFE, PCTFE, PTFE, and PFA.

The ferrule is preferably formed of a resin material. Examples of the resin material include PEEK, PP, ETFE, and PCTFE. The material constituting the ferrule is preferably a material having a tensile strength of preferably 20 MPa or more, more preferably 30 MPa or more, and preferably 300 MPa or less, more preferably 200 MPa or less. When the tensile strength of the ferrule is within such a range, the ferrule can be more reliably brought into close contact with each of the surface of the microfluidic chip and the tube by the pressing from the pressing member, and the liquid tightness can be excellently maintained.

A tube can be connected to the other end side of the connector. The tube is preferably formed of a resin material, but may also be formed of a metal material such as stainless steel. Examples of the resin material include PEEK, PTFE, and PFA.

The microfluidic chip 3 includes a first supply flow path 31 through which the first fluid flows and a second supply flow path 32 through which the second fluid flows. Both the first supply flow path 31 and the second supply flow path 32 have downstream ends joined to each other so that both the fluids merge, and a mixing/diluting flow path 33 through which a mixed fluid obtained by mixing the first and second fluids flows is provided on the downstream side of a junction 34. As illustrated in FIG. 4, openings 311, 321 that are opened to the upper surface of the chip are provided at each of upstream ends of the first and second supply flow paths 31, 32, and an opening 331 that is similarly opened to the upper surface of the chip is provided at a downstream end of the mixing/diluting flow path 33.

The microfluidic chip 3 is arranged and fixed in the recesses 213, 214 of the chip holder 21 connected and fixed in a state where the cover 211 and the base 212 are overlapped by the fixtures 22. In this state, the upper surface of the microfluidic chip 3 and an inner surface of the recess 213 of the cover 211 are in close contact with each other in a liquid-tight manner, and the tip ends of the connectors 23, 24, 25 that are screwed into the screw holes 215, 216, 217 of the cover 211 are in close contact with the openings 311, 321, 331, respectively. The flow holes provided in the connectors 23, 24, 25 communicate with the first supply flow path 31, the second supply flow path 32, and the mixing/diluting flow path 33 via the openings 311, 321, 331, respectively. Here, in the examples of FIGS. 3 and 4, the openings 311, 321, 331 of the flow paths are formed on one surface of the microfluidic chip 3; however, in a case where any of these openings is formed on the other surface side and there is an opening on both surfaces of the microfluidic chip 3, screw holes corresponding to the screw holes 215, 216, 217 may be provided in the cover 211 and the base 212 according to each opening, and connectors corresponding to the connectors 23, 24, 25 may be attached.

Here, in the microfluidic device 2, although not particularly limited, the flatness of the surface of the microfluidic chip 3 that comes in contact with the cover 211 and the flatness of the surface of the microfluidic chip 3 that comes in contact with the base 212 are both preferably 50 μm or less, more preferably 30 μm or less, still more preferably 20 μm or less, particularly preferably 15 μm or less, and more particularly preferably 10 μm or less. As the flatness, a thickness variation (TTV: total thickness variation) can be applied.

Although not particularly limited, the planarity of the surface of the cover 211 that comes in contact with the microfluidic chip 3 and the planarity of the surface of the base 212 that comes in contact with the microfluidic chip 3 are both preferably 50 μm or less, more preferably 30 μm or less, still more preferably 20 μm or less, particularly preferably 15 μm or less, and more particularly preferably 10 μm or less. As the planarity, planarity defined in JIS B 0621 can be applied.

By adjusting the flatness and planarity as described above, even when a fluid sample is fed into the microfluidic chip 3 at a high pressure, tensile stress and compressive stress applied to the microfluidic chip 3 are effectively dispersed in the chip holder 21, and the load on the microfluidic chip 3 itself is reduced, so that the microfluidic chip 3 is less likely to be deformed, liquid leakage at the contact portion and damage to the microfluidic chip are effectively suppressed, and an object can be more favorably and stably manufactured.

Furthermore, although not particularly limited, the flatness of each of the portions of the surface of the microfluidic chip 3 with which the tip ends of the connectors 23, 24, 25 are in contact is preferably 50 μm or less, more preferably 30 μm or less, still more preferably 20 μm or less, particularly preferably 15 μm or less, and more particularly preferably 10 μm or less. As the flatness, a thickness variation (TTV: total thickness variation) is applied.

By adjusting the flatness of the surface of the microfluidic chip 3 with which the tip ends of the connectors 23, 24, 25 are in contact as described above, the microfluidic chip 3 is less likely to be damaged, and further, the liquid tightness at the connection portions with the flow paths of the microfluidic chip 3 is increased, and thus liquid leakage is less likely to occur even when a fluid sample is fed into the flow paths of the microfluidic chip at a high pressure.

The flatness of the surface of the microfluidic chip 3 and the planarity of the surfaces of the cover 211 and the base 212 can be adjusted by polishing the surfaces of the microfluidic chip 3, the cover 211, and the base 212. The flatness of the surface of the microfluidic chip 3 and the planarity of the surfaces of the cover 211 and the base 212 may be the predetermined flatness or planarity at least at a portion where the microfluidic chip 3 is in contact with the cover 211 and the base 212, and furthermore, it is sufficient that the flatness of the surface of the microfluidic chip 3 be the predetermined flatness at the portions with which the tip ends of the connectors 23, 24, 25 are in contact.

The microfluidic chip 3 is not particularly limited, but is preferably formed of synthetic quartz glass from the viewpoint of long-term stability, weather resistance, chemical resistance, and the like. The synthetic quartz glass can be obtained by forming a synthetic quartz glass ingot manufactured by a conventional method into a predetermined size and thickness, and then subjecting the surface to lapping polishing, rough polishing, precision polishing, or the like as necessary.

Preferable examples of the cross-sectional shape of the flow paths 31, 32, 33 formed inside the microfluidic chip 3 include a quadrangular shape, a circular shape, a semicircular shape, and a substantially semicircular shape. The length, width, and height of the flow paths can be appropriately selected according to the application of the microfluidic chip 3 to be used; however, the width is usually 0.01 μm or more and usually 100,000 μm or less, and the height is usually 0.01 μm or more and usually 100,000 μm or less. The height is usually formed to be about 90% or less of the thickness of the microfluidic chip 3.

The size of the openings 311, 321, 331 of the microfluidic chip 3 is not particularly limited as long as the openings communicate with the flow paths 31, 32, 33. Preferable examples of the shape of the openings include a circular shape and a polygonal shape. The size of the openings (the size along the surface of the microfluidic chip) is not particularly limited as described above; however, from the viewpoint of manufacturing or handling, the length of one side is preferably 0.1 to 5 mm in the case of a polygonal opening, and the diameter is preferably 0.1 to 5 mm in the case of a circular opening.

The microfluidic chip 3 usually has a plate shape. The shape of the surface of the microfluidic chip 3 in contact with the cover 211 and the base 212 is preferably a quadrangular shape such as a rectangle, a circular shape, or the like from the viewpoint of case of manufacturing. With such a shape, the microfluidic chip 3 can be in good contact with the cover 211 and the base 212, and the microfluidic device can be reliably configured. The size of the surface of the microfluidic chip 3 is not particularly limited; however, for example, the length of one side is preferably 10 to 1000 mm in the case of a quadrangular shape, and the diameter is preferably 10 to 1000 mm in the case of a circular shape. On the other hand, the thickness of the microfluidic chip 3 is not particularly limited, but is preferably 0.01 mm or more, more preferably 0.1 mm or more, still more preferably 0.5 mm or more, and preferably 300 mm or less, more preferably 100 mm or less, still more preferably 15 mm or less. When the thickness is in such a range, rigidity of the microfluidic chip 3 can be secured, damage at the time of handling can be reduced, and further, this contributes to weight reduction of the microfluidic chip 3.

With such a configuration of the microfluidic device 2, fluid communication between the discharge outlets of the continuous flow pumps 11, 12 and the supply ports of the microfluidic device 2 and between the discharge port of the microfluidic device and the system outlet is improved, and pulsation in the continuous flow can be suppressed even when a fluid sample is fed in at a high pressure.

In the microfluidic chip 3, the first fluid flowing through the first supply flow path 31 and the second fluid flowing through the second supply flow path 32 are mixed and diluted when the first fluid and the second fluid merge at the junction 34 and flow through the mixing/diluting flow path 33. Here, the structure of the mixing/diluting flow path 33 is not particularly limited, and may be, for example, a known three-dimensional micromixer structure capable of achieving instantaneous mixing of two liquids. However, since lipid nanoparticles having high size uniformity and high particle size controllability can be formed when producing self-assembled substance particles, it is preferable to use a flow path structure having a simple two-dimensional structure in which baffles having a constant width with respect to the flow path width are alternately arranged on both side surfaces as described in, for example, WO 2018-190423.

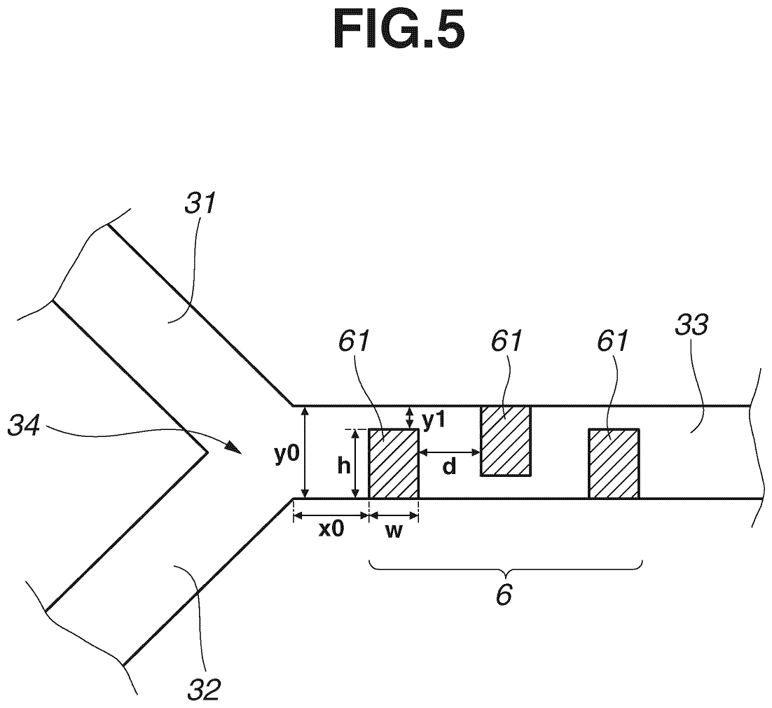

Specifically, a flow path structure having a bent flow path portion 6 as shown in FIG. 5 can be preferably used. That is, as described above, in the flow paths of the microfluidic chip 3, the first supply flow path 31 for supplying the first fluid and the second supply flow path 32 for supplying the second fluid, which are independent of each other, are joined to each other with a constant length on the upstream side (left side in the drawing), and one mixing/diluting flow path 33 is formed on the downstream side from the junction 34, and it is preferable that at least a part of the mixing/diluting flow path 33 has the bent flow path portion 6 that is two-dimensionally bent.

For example, when an axial direction or an extension direction of the mixing/diluting flow path 33 upstream of the bent flow path portion 6 is an X direction, and a width direction of the diluting flow path orthogonal to the X direction is a Y direction, the bent flow path portion 6 can be configured by a plurality of structural elements 61 arranged so as to protrude from both side walls facing each other along the Y direction toward the inside of the flow path and alternately arranged at predetermined intervals along the X direction.

In the structural elements 61 forming the bent flow path portion 6, when a width in the Y direction of the mixing/diluting flow path 33 on the upstream side of the bent flow path portion 6 is [y0], a protrusion width h in the Y direction in the mixing/diluting flow path is preferably ½ [y0] or more and less than 1 [y0], more preferably ½ [y0] or more and 39/40 [y0] or less, and still more preferably ½ [y0] or more and ¾ [y0] or less. As a result, the flow paths y1 having a width larger than 0 and ½ [y0] or less of the upstream flow path width y0 are alternately formed at predetermined intervals. The protrusion widths h of the structural elements 61 are not necessarily the same in all the structural elements 61, and may be different from each other as long as the predetermined condition described above is satisfied. The flow path width y1 formed in this manner may also be different at each formation location of each structural element 61. For example, an aspect may be adopted in which the protrusion width h of each structural element 61 gradually increases in the downstream direction, and the flow path width y1 gradually decreases. The flow path has a bent shape at a portion where each structural element 61 is present, and the flow path width y1 is narrowed to ½ [y0] or less, whereby the mixing efficiency is improved and the efficiency of molecular diffusion in the fluid is improved.

Further, the width w of the structural element 61 in the X direction may be different or constant in each structural element 61, and the distance d between the structural elements 61 may be different or constant. For example, the width w and the distance d may be gradually increased or decreased in the downstream direction. The width w in the X direction of the structural element 61 is preferably about 1/10 [y0] or more and 5 [y0] or less when the width in the Y direction of the mixing/diluting flow path 33 on the upstream side of the bent flow path portion 6 is defined as [y0]. Furthermore, the distance x0 from the junction 34 of the first and second supply flow paths 31, 32 to the first structural element 61 is not particularly limited and can be appropriately set, but it is preferable to provide a distance equal to or longer than the width w of the structural element.

Specific values of the protrusion width h and the width w in the X direction of the structural element 61, and the distance d between the structural elements are not particularly limited, because, for example, in a case where a self-assembled substance particle such as a lipid particle is to be obtained, the specific values depend on the size of the particle, the number of structural elements 61, the length and width of the mixing/diluting flow path 33, and other conditions. However, values are specifically as follows.

For example, when the flow path width [y0] of the mixing/diluting flow path 33 on the upstream side is 200 μm, the protrusion width h of the structural element 61 is preferably 100 or more and less than 200 μm. Therefore, in the bent flow path portion 6 where each structural element 61 is present, the flow path width y1 is preferably larger than 0 and about 100 μm or less. In addition, when the flow path width [y0] on the upstream side of the mixing/diluting flow path 33 is 20 to 1000 μm, typically 200 μm, the width w of each structural element 61 is preferably about 20 to 1000 μm. In this case, the widths w of the structural elements 61 are not necessarily the same, and may be different from each other as described above.

In addition, the distance d between the structural elements 61 depends on the size of the lipid particles to be obtained and other conditions such as the number, height h, and width w of the structural elements 61, but is preferably 1/10 [y0] or more and 5 [y0] or less with respect to the flow path width [y0] on the upstream side of the mixing/diluting flow path 33. Specifically, for example, in a case where the upstream flow path width [y0] is 20 to 1000 μm, typically 200 μm, the distance d between the adjacent structural elements 61 is desirably about 20 to 1000 μm. The distances d between the adjacent structural elements 61 are not necessarily the same, and may be different. For example, an aspect may be employed in which the distance d gradually decreases in the downstream direction.

The flow path width y0 of the mixing/diluting flow path 33 from the junction 34 of the first supply flow path 31 and the second supply flow path 32 to the first structural element 61 is not particularly limited, but is preferably about 0.01 to 100,000 μm, and more preferably about 10 to 10,000 μm, for example, from the viewpoint of mass production of lipid nanoparticles having high size uniformity in the production of self-assembled substance particles.

In FIG. 5, each structural element 61 constituting the bent flow path portion 6 is an object having wall surfaces orthogonal to the X direction along the axis of the mixing/diluting flow path 33. However, this angle is not necessarily strictly required to be 90°, and even a structural element inclined to some extent can be an effective configuration, and is not particularly limited. Specifically, for example, the angle is preferably in the range of about 30 to 150°, more preferably 40 to 140°, and still more preferably 80 to 100°, which is sufficiently acceptable. Furthermore, the shape of a corner on the flow path side of each structural element 61 is also allowed to have a certain degree of roundness, and is not particularly limited, but may be allowed as long as it is, for example, R50 μm or less, more desirably R20 μm or less. However, in order to obtain more controllable and uniform nano-sized lipid particles and the like, it is desirable that these allowable values be as small as possible. Further, in the embodiment shown in FIG. 5, the axial direction of the mixing/diluting flow path 33 in the flow path structure or the X direction that is the extension direction thereof is represented linearly for convenience; however, the X direction merely indicates the axial direction of the mixing/diluting flow path 33, and in practice, the direction is not limited to such a linear direction, and may be curved with a certain curvature, for example. Note that the Y direction, which is the width direction of the mixing/diluting flow path 33 orthogonal to the curved X direction, refers to a direction orthogonal to the tangent of the axis of the portion.

In addition, in the example illustrated in FIG. 5, the bent flow path portion 6 has a form in which substantially rectangular baffles (structural elements 61) are alternately arranged on both side surfaces in the flow path, but is not limited to one configured by arranging separate baffles on the flow path in this manner. That is, the configuration of the structural elements 61 is not particularly limited as long as a flow path having a similar shape is formed so as to correspond to the flow path formed by disposing such baffles. As the structural elements 61 as described above, a flow path shape having a two-dimensional structure in which the wall surface of the mixing/diluting flow path 33 is integrally formed while being bent into a predetermined shape (while maintaining a substantially constant wall thickness) to be refracted, contracted and expanded according to the above-described definition may be formed, and the bent flow path portion 6 in the present invention naturally includes such an aspect.

In addition, since the flow path structure including the first and second supply flow paths 31, 32 and the mixing/diluting flow path 33 is a flow path structure having a two-dimensional structure as described above, the dimension of the flow path in the depth direction (paper thickness direction in FIG. 5) is not particularly limited, but is preferably, for example, about 0.01 to 100,000 μm, and more preferably about 10 to 1,000 μm.

In FIGS. 3 to 5, the flow path structure including two supply flow paths 31, 32 and one mixing/diluting flow path 33 is used. However, in the present invention, it is sufficient that a plurality of supply flow paths, which are independent from each other and have a certain length, join to form one mixing/diluting flow path, and for example, three supply flow paths may be provided. In the case of having three supply flow paths, it is preferable that the first supply flow path 31, the second supply flow path 32, and a third supply flow path, each having a certain length, are joined to each other so that the first fluid introduced from the first supply flow path 31 is in contact with a third fluid introduced from the third supply flow path before joining the second fluid introduced from the second supply flow path 32 to form one mixing/diluting flow path 33.

The mixing and dilution of the fluid in the flow path structure depends on molecular diffusion in the case of producing self-assembled substance particles such as lipid particles, for example, and the higher the dilution rate of the lipid solution or the like as a raw material, the smaller the size of the generated lipid particles or the like. Therefore, by adjusting the protrusion width h, the width w, the arrangement, and the like of each of the structural elements 61 (baffles), the dilution rate of the raw material solution can be controlled, and nanoparticles having higher particle size controllability than before can be formed.

Although the microfluidic device 2 has been described above with reference to FIGS. 3 to 5, the microfluidic device in the present invention is not limited to the microfluidic device 2 illustrated in FIGS. 3 to 5, and for example, the shape and material of the cover 211 and the base 212 constituting the chip holder 21, the shape and material of the microfluidic chip 3, the configuration of the flow paths, the method and form of fixing the microfluidic chip 3 to the chip holder 21, and the like may be appropriately changed without departing from the gist of the present invention.

A discharge side of the first continuous flow pump 11 is connected to the connector 23 of the microfluidic device 2, and the first fluid is supplied from the first reservoir 112 to the first supply flow path 31 of the microfluidic chip 3 via the connector 23 by the first continuous flow pump 11 as illustrated in FIG. 1. A discharge side of the second continuous flow pump 12 is connected to the connector 24 of the microfluidic device 2, and the second fluid is supplied from the second reservoir 122 to the second supply flow path 32 of the microfluidic chip 3 via the connector 24 by the second continuous flow pump 12 as illustrated in FIG. 1.

The first fluid introduced into the first supply flow path 31 and the second fluid introduced into the second supply flow path 32 merge at the junction 34 of the flow paths, and are mixed while flowing through the mixing/diluting flow path 33, and the mixed fluid is discharged from the microfluidic device 2 from the downstream end of the mixing/diluting flow path 33 via the connector 25. A discharge flow path 4 is connected to the connector 25 connected to the downstream end of the mixing/diluting flow path 33, and the mixed fluid discharged from the microfluidic device 2 is collected in a sample container 51 via the discharge flow path 4.

As shown in FIG. 1, the discharge flow path 4 can also be provided with a waste collection flow path 523 branching via a waste valve 521, for example. As a result, during priming of the system or other non-production operation (for example, operation up until particle production is stabilized, or operation for washing the flow path), the waste can be collected into a waste container 52 via the waste collection flow path 523.

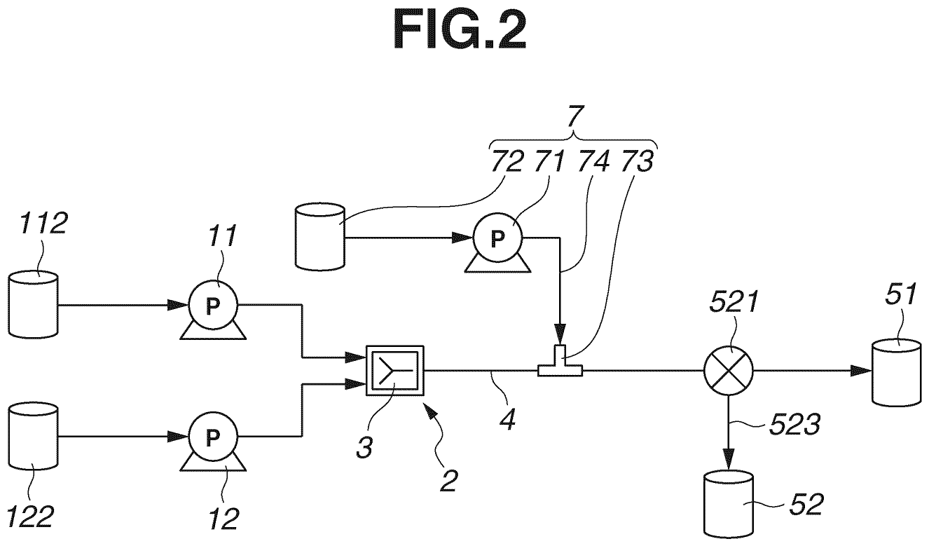

Furthermore, the system of the present invention is not particularly limited; however, as shown in FIG. 2, a diluting portion 7 for introducing a diluent solution may be provided in an intermediate portion (when the waste collection flow path 523 is provided, it is located upstream of the waste valve) of the discharge flow path 4. The diluting portion 7 includes a third continuous flow pump 71 that continuously supplies a diluent solution, and a suction side thereof is connected to a third reservoir 72 that stores the diluent solution, and a discharge side thereof is connected to the discharge flow path 4 via a diluting flow path 74 and a T-shaped connector 73.

By providing the diluting portion 7, the diluent solution is continuously added to the mixed fluid flowing through the discharge flow path 4, and for example, the pH of the solution is adjusted, whereby the manufactured particles can be stabilized. Note that, in the system illustrated in FIG. 2, configuration other than the diluting portion 7 is the same as that of the system in FIG. 1, and the same portions are denoted by the same reference numerals, and the descriptions thereof are omitted.

The continuous flow microfluidic system of the present invention can be applied to various applications as long as it is intended to mix a first fluid and a second fluid while causing the first fluid and the second fluid to flow in a trace amount. For example, the continuous flow microfluidic system is suitably used in a case where a solution containing self-assembled substance particles such as lipids and amphipathic substances is continuously introduced as the first fluid, and a dilution medium is continuously introduced as the second fluid, and the self-assembled substance particles as an object are formed by diluting the self-assembled substance-containing solution of the first fluid with the dilution medium of the second fluid.

At that time, in the system of the present invention, the pulsation rate of the continuous flow formed by the system is adjusted to 5% or less, preferably 1% or less, and more preferably 0.5% or less. The pulsation rate (Xs) of the continuous flow formed by the system is calculated by the following formula (1).

$$X s = \frac{1}{2} \times \{ \frac{( Q max - Q min )}{Q a v e} \} \times 100 [ \pm \% ] \qquad ( 1 )$$

Here, Qmax in the equation is a maximum value of flow rate of a conveyed fluid in a predetermined time, and Qmin is a minimum value of the flow rate of the conveyed fluid in the same predetermined time. In addition, Qave is an average flow rate of the conveyed fluid within the same predetermined time.

The pulsation rate of the continuous flow formed by the system of the present invention is preferably confirmed between the discharge outlets of the continuous flow pumps 11, 12 and supply portions to the microfluidic device 2 (the connectors 23, 24 in the examples of FIGS. 1 to 4), and between the discharge portion from the microfluidic device 2 (the connector 25 in the examples of FIGS. 1 to 4) and the system outlet (downstream end of the discharge flow path 4 in the examples of FIGS. 1 to 4).

When the pulsation rate of the continuous flow exceeds 5%, mixing progresses slowly before and after the junction 34 (see FIGS. 4 and 5), and particularly, in a case in which the bent flow path portion 6 is provided, mixing progresses slowly between the junction 34 and the bent flow path portion 6 of the mixing/diluting flow path 33, and thus coarse particles are likely to be formed and the size uniformity of the lipid nanoparticles decreases. Note that the lower limit of the pulsation rate is not particularly limited, and is preferably as low as possible.

In order to control the pulsation rate of the continuous flow formed by the system of the present invention, the pulsation rate of the continuous flow pump is preferably 5% or less, more preferably 1% or less, and still more preferably 0.5% or less. The pulsation rate (Xp) of the continuous flow pump is calculated by the following formula (2).

$$Xp = \frac{1}{2} \times \{ \frac{( Q max - Q min )}{Q a v e} \} \times 100 [ \pm \% ] \qquad ( 2 )$$

Here, Qmax is a maximum value of the flow rate of the conveyed fluid in a predetermined time, and Qmin is a minimum value of the flow rate of the conveyed fluid in the same predetermined time. In addition, Qave is an average flow rate of the conveyed fluid within the same predetermined time.

When the pulsation rate of the continuous flow pump is equal to or less than the value described above, it is possible to suppress gradual mixing up to the mixing/diluting flow path 33 of the microfluidic device 2.

The system of the present invention may use a software system that controls manufacturing parameters. The manufacturing parameters include, but are not limited to, fluid flow rate, independent fluid flow rate ratio, pressure in the device, temperature control, and the like. Such software control is generally known to those skilled in the art.

Next, a method for producing self-assembled substance particles of the present invention is described. The production method of the present invention includes a step of diluting a self-assembled substance-containing solution with a dilution medium to obtain a liquid containing self-assembled substance particles, and this step is performed using the continuous flow microfluidic system of the present invention described above.

That is, referring to FIGS. 1 to 5, the self-assembled substance-containing solution is supplied from the first reservoir 112 to the microfluidic device 2 by the first continuous flow pump 11, and a dilution medium is supplied from the second reservoir 122 to the microfluidic device 2 by the second continuous flow pump 12. The self-assembled substance-containing solution supplied from the first continuous flow pump 11 flows into the first supply flow path 31 of the microfluidic chip 3 via the connector 23 of the microfluidic device 2, and the dilution medium supplied from the second continuous flow pump 12 flows into the second supply flow path 32 of the microfluidic chip 3 via the connector 24 of the microfluidic device 2. The self-assembled substance-containing solution flowing through the first supply flow path 31 and the dilution medium flowing through the second supply flow path 32 are joined and brought into contact with each other at the junction 34 of the supply flow paths 31, 32 to become a mixed fluid and flow through the mixing/diluting flow path 33, and at that time, the self-assembled substance-containing solution is diluted with the dilution medium to form self-assembled substance particles. Then, the mixed fluid containing the formed self-assembled substance particles is discharged from the microfluidic device 2 from the downstream end of the mixing/diluting flow path 33 via the connector 25, and collected in the sample container 51 via the discharge flow path 4.

The self-assembled substance particle formed in the present invention is a particle containing a self-assembled substance as a particle constituent. A particle containing a self-assembled substance as a particle constituent is a particle obtained by associating self-assembled substances to form a particle, and a substance to be encapsulated coexisting in a system during particle formation can also be incorporated into the particle. Constituent components of the particle formed under the condition that the encapsulated substance coexists are at least a self-assembled substance and an encapsulated substance.

The self-assembled substance-containing solution and the dilution medium can be caused to flow into a single mixing/diluting flow path 33 so that, for example, a total flow rate is 3 L/h or more. However, the total flow rate is not limited to this range, and can be appropriately determined in consideration of the structure and dimensions of the flow path structure, the type of the self-assembled substance-containing solution and the dilution medium, the particle diameter of the desired self-assembled substance particles, the encapsulation efficiency of the encapsulated substance, and the like. From the viewpoint of mass production of self-assembled substance particles having high size uniformity, the total flow rate of the self-assembled substance-containing solution and the dilution medium can be, for example, in the range of 3 L/h to 20 L/h.

The ratio (V1:V2) between the flow rate V1 of the self-assembled substance-containing solution supplied as the first fluid and the flow rate V2 of the dilution medium supplied as the second fluid can be, for example, in the range of 1:1 to 1:20. However, the present invention is not limited to this range, and the range can be appropriately selected within a range in which a target particle can be obtained.

The self-assembled substance-containing solution can be, for example, any solution selected from a group consisting of a neutral lipid-containing solution, an anionic lipid-containing solution, a cationic lipid-containing solution, and a polymer-containing solution, but is not limited thereto. The self-assembled substance in the present invention may be any substance as long as it has a self-assembling function, and as described above, the self-assembled substances can associate with each other and form particles.

The lipid as an example of the self-assembled substance is not particularly limited, and examples thereof include naturally occurring lipids such as soybean lecithin, hydrogenated soybean lecithin, egg yolk lecithin, phosphatidylcholines (for example, egg PC derived from egg), phosphatidylserines, phosphatidylethanolamines, phosphatidylinositols, phosphasphingomyelins, phosphatidic acids, long-chain alkyl phosphates, gangliosides, glycolipids, phosphatidylglycerols, sphingolipids, sterols, and lysophospholipids, and non-naturally occurring lipids. In addition, cationic non-naturally occurring lipids considered suitable as constituents of a liposome for nucleic acid delivery can be used, such as N,N-dioleyl-N,N-dimethylammonium chloride (DODAC),
N-(2,3-dioleyloxy) propyl)-N,N,N-trimethylammonium chloride (DOTMA),
N,N-distearyl-N,N-dimethylammonium bromide (DDAB),
N-(2,3-dioleoyloxy) propyl)-N,N,N-trimethylammonium chloride (DOTAP),
3-(N—(N′,N′-dimethylaminoethane)-carbamoyl) cholesterol (DC-Chol) and
N-(1,2-dimyristyloxyprop-3-yl)-N,N-dimethyl-N-hydroxyethylammonium bromide (DMRIE), Lipofectin®, Lipofectamine®, Transfectam®,
1,2-dioleoyl-3-dimethylammonium-propane (DODAP),
1,2-dioleyloxy-3-dimethylaminopropane (DODMA),
(N,N-dimethyl-2,3-bis(tetradecyloxy) propane-1-amine (DMDMA),
1,2-dilinoleyloxy-N,N-dimethylaminopropane (DLinDMA),
1,2-dilinolenyloxy-N,N-dimethylaminopropane (DLenDMA),
1,2-dilinoleyoxy-3-(dimethylamino) acetoxypropane (DLin-DAC),
1,2-dilinoleyoxy-3-morpholinopropane (DLin-MA),
1,2-dilinoleoyl-3-dimethylaminopropane (DLinDAP),
1,2-dilinoleylthio-3-dimethylaminopropane (DLin-S-DMA),
1-linoleoyl-2-linoleyloxy-3-dimethylaminopropane (DLin-2-DMAP),
2,2-dilinoleyl-4-(2-dimethylaminoethyl)-[1,3]-dioxolane (DLin-KC2-DMA),
(6Z,9Z,28Z,31Z)-heptatriaconta-6,9,28,31-tetraene-19-yl-4-(dimethylamino) butanoate (DLin-MC3-DMA), 1,2-dilinoleyloxy-3-trimethylaminopropane chloride salt (DLin-TMA-Cl),
1,2-dilinoleoyl-3-trimethylaminopropane chloride salt (DLin-TAP-Cl),
1,2-dilinoleyloxy-3-(N-methylpiperazino) propane (DLin-MPZ),
3-(N,N-dilinoleylamino)-1,2-propanediol (DLinAP), 3-(N,N-dioleylamino)-1,2-propanedio (DOAP), 1,2-dilinoleyloxo-3-(2-N,N-dimethylamino) ethoxypropane (DLin-EG-DMA) and
2,2-dilinoleyl-4-dimethylaminomethyl-[1,3]-dioxolane (DLin-K-DMA),
1-palmitoyl-2-oleoyl-sn-glycero-3-phosphocholine (POPC), and
1,2-distearoyl-sn-glycero-3-phosphocholine (DSPC). The aforementioned
2,2-dilinoleyl-4-(2-dimethylaminoethyl)-[1,3]-dioxolane (DLin-KC2-DMA),
(6Z,9Z,28Z,31Z)-heptatriaconta-6,9,28,31-tetraene-19-yl-4-(dimethylamino) butanoate (DLin-MC3-DMA) and analogs thereof are described in JP-A 2013-245190, JP-A 2016-84297, and JP-A 2019-151589.

The self-assembled substance may be an amphipathic substance. The amphipathic substance as an example of the self-assembled substance is not particularly limited, and examples thereof include amphiphilic polymer compounds, e.g., amphipathic block copolymers such as polystyrene-polyethylene oxide block copolymers, polyethylene oxide-polypropylene oxide block copolymers, polylactic acid polyethylene glycol copolymers, and polycaprolactone-polyethylene glycol copolymers.

Examples of the encapsulated substance include, but are not particularly limited to, biological polymers such as nucleic acids, peptides, proteins, and sugar chains; and substances such as metal ions, low or middle molecular organic compounds, organometallic complexes, and metal particles; and from the viewpoint of application, medical agents, physiologically active substances, cosmetics, and the like, such as anticancer agents, antioxidants, antibacterial agents, anti-inflammatory agents, vitamins, artificial blood (hemoglobin), vaccines, hair growth agents, moisturizers, colorants, skin lightening agents, and pigments. These encapsulated substances can be contained in the aqueous phase of the particles to be formed as long as they are water-soluble. In the case of a water-soluble charged substance, it is also possible to form an aggregate with a self-assembled substance having an opposite charge, and at the same time, it is also possible to form self-assembled substance particles using the aggregate as a core and incorporate the self-assembled substance particles into the particles. When the encapsulated substance is poorly soluble in water, the substance may be contained in a hydrophobic portion of a self-assembled membrane formed by the self-assembled substance, or may be contained in particles as an aggregate that is bound to and aggregated with the hydrophobic portion of the self-assembled substance.

The water-miscible organic solvent used for dissolving the self-assembled substance to prepare the particle solution is not particularly limited, and examples thereof include organic solvents that can be mixed with water, such as alcohols, ethers, esters, ketones, and acetals. In particular, it is preferable to use alcohols such as methanol, ethanol, t-butanol, butanediols, 1-propanol, 2-propanol, and 2-butoxyethanol, particularly alkanols having 1 to 6 carbon atoms. In addition, ethers such as tetrahydrofuran, acetonitrile, acetone, and the like are also exemplified.

Next, as the dilution medium used as the second fluid, water, or an aqueous solution basically containing water as a principal component, for example, physiological saline, a phosphate buffer solution, an acetate buffer solution, a citrate buffer solution, a malate buffer solution, 2-morpholinoethanesulfonic acid (MES), 4-(2-hydroxyethyl) piperazine-1-ethanesulfonic acid (HEPES), trishydroxymethylaminomethane (Tris), ethylenediaminetetraacetic acid (EDTA), or the like is appropriately used according to the use of the particles to be formed, or the like. The dilution medium can also be a solution in which a water-soluble substance is further contained in these solutions in addition to the aqueous solution and the buffer solution. Examples of the water-soluble substance include a low molecular weight substance, a medium molecular weight substance, a high molecular weight substance, a nucleic acid, a protein, a peptide, a physiologically active substance containing them, a pharmaceutical product, a cosmetic material, a vaccine, an adjuvant, and the like. Examples of the dilution medium further containing a water-soluble substance include a low-molecular-weight substance-containing aqueous solution, a medium-molecular-weight substance-containing aqueous solution, a high-molecular-weight substance-containing aqueous solution, a nucleic acid-containing aqueous solution, a protein-containing aqueous solution, a peptide-containing aqueous solution, a physiologically active substance-containing aqueous solution, a pharmaceutical-containing aqueous solution, a cosmetic material-containing aqueous solution, a vaccine-containing aqueous solution, an adjuvant-containing aqueous solution, and a mixed solution thereof. Among these, an aqueous solution, a buffer solution, a nucleic acid-containing aqueous solution, a protein-containing aqueous solution, a peptide-containing aqueous solution, an adjuvant-containing aqueous solution, and the like are particularly preferably used.

The self-assembled substance particles obtained by the method of the present invention can be nano-sized, particles having a Z-average particle diameter in the range of, for example, 10 to 1000 nm can be obtained, and further particles having a Z-average particle diameter in the range of 20 to 200 nm can be obtained. However, the present invention is not limited to this range. The Z-average particle diameter is also called a cumulative average (harmonic intensity obtained by averaging diameters of particles), and is defined in ISO 13321.

### EXAMPLES

Hereinafter, the present invention is described more specifically with reference to an Example and a Comparative Example; however, the present invention is not limited to the following Examples.

### Example 1, Comparative Example 1, and Reference Examples 1 and 2

Lipid nanoparticles were produced using the continuous flow microfluidic system shown in FIG. 1 as follows.

### <Continuous Flow Microfluidic System>

As shown in FIG. 1, the continuous flow microfluidic system includes two continuous flow pumps 11, 12, the microfluidic device 2, the discharge flow path 4, the waste valve 521, and the waste collection flow path 523, and both reservoirs 112, 122 were communicated with the outlet of the discharge flow path 4 by tubes. The pulsation rate of the continuous flow formed by this system was adjusted as shown in Table 1.

The microfluidic device 2 constituting this system is as shown in FIGS. 3 and 4, and includes the microfluidic chip 3, the chip holder 21 (the cover 211, the base 212, and the fixtures 22), and the connectors 23, 24, 25, and is as follows.

The microfluidic chip 3 was made of synthetic quartz glass having a size of 30 mm×70 mm and a thickness of 1.8 mm, and the flow paths had a flow path structure having the basic structure illustrated in FIG. 5, in which the flow path depth=500 μm, the flow path width y0=2000 μm, the height h of each structural element 61=1000 μm, the width w of each structural element 61=1000 μm, the distance d between adjacent structural elements 61=1000 μm, and the number of structural elements 61=20. Each of the supply holes 311, 321 and the discharge hole 331 (see FIG. 4) had a circular shape with a diameter of 2.0 mm.

Each of the cover 211 and the base 212 was made of stainless steel (SUS 304) having a size of 60 mm×100 mm and a thickness of 7 mm, and the size of each of the recesses 213, 214 into which the microfluidic chip 3 was fitted was 30.1 mm×70.1 mm and a depth of 0.5 mm. Each screw-shaped fixture 22 was an M5 screw, and the number of the screw-shaped fixtures was seven unlike FIGS. 3 and 4, and seven screw-shaped holes corresponding to the fixtures 22 were formed in each of the cover 211 and the base 212. In addition, three screw-shaped (M6 screw) connectors 23, 24, 25 were used, and three screw holes 215, 216, 217 corresponding to the connectors were formed in the cover 211. The pressing members of the connectors were made of PEEK, and the ferrules were made of PTFE. In addition, the tubes were made of PEEK.

The flatness of the surface of the microfluidic chip 3 facing the cover 211 and the base 212, the planarity of the surfaces of the cover 211 and the base 212 facing the microfluidic chip 3, and the flatness of the surface of the microfluidic chip 3 at the portions where the tip ends (ferrules) of the connectors 23, 24, 25 are in contact were adjusted as shown in Table 1.

As shown in FIGS. 3 and 4, the microfluidic chip 3 was fitted into the recesses 213, 214 of each of the cover 211 and the base 212, the fixtures 22 were screwed into the holes to connect the cover 211 and the base 212, and the microfluidic chip 3 was sandwiched and fixed between the cover 211 and the base 212. In addition, the connectors 23, 24, 25 were screwed into the screw holes 215, 216, 217 of the cover 211, respectively, to press the ferrules of the connectors, thereby fixing the connectors 23, 24, 25 to the cover 211 and bringing the connectors into contact with the surface of the microfluidic chip 3.

TABLE 1

| | | Example | Comparative | Reference | Reference |
|---|---|---|---|---|---|
| | | 1 | Example 1 | Example 1 | Example 2 |
| Flatness of | Surface in contact with cover | 10 | 10 | 100 | 10 |
| microfluidic | Surface in contact with base | 10 | 10 | 100 | 10 |
| chip [μm] | Surface in contact with connector | 10 | 10 | 100 | 10 |

| | | | | |
|---|---|---|---|---|
| Planarity of surface of cover [μm] | 10 | 10 | 10 | 100 |
| Planarity of surface of base [μm] | 10 | 10 | 10 | 100 |
| Pulsation rate of continuous flow [%] | ±0.1 | ±8.0 | ±0.1 | ±0.1 |

### <Production of Lipid Nanoparticles>

The following self-assembled substance-containing solution was supplied as a first fluid from the first reservoir 112 into the system by the first continuous flow pump 11, and the following dilution medium was supplied as a second fluid from the second reservoir 122 into the system by the second continuous flow pump 12, thereby producing lipid nanoparticles under the following conditions.

Self-assembled substance-containing solution: 10
mg/mL phosphatidylcholine solution in ethanol

| | |
|---|---|
| Dilution medium: | physiological saline |
| Total flow rate: | 120 mL/min |
| Flow rate ratio: | 1:3 (self-assembled substance- |
| | containing solution:dilution medium) |
| Dialysis: | D-PBS (—) |
| Particle size measurement: | DLS |

In Example 1, liquid leakage and damage of the microfluidic chip were not confirmed, and the generation of highly uniform 20 nm lipid nanoparticles was confirmed. In Comparative Example 1, liquid leakage and damage of the microfluidic chip were not confirmed, but coarse particles other than the target particles of 20 nm were confirmed. In Reference Example 1, liquid leakage was occasionally observed at the contact portions between the microfluidic chip and the connectors, and there was a possibility that production of lipid nanoparticles was hindered. In Reference Example 2, under the above conditions, the microfluidic chip was damaged, and it was difficult to produce lipid nanoparticles.

Japanese Patent Application Nos. 2024-160541 and 2024-196075 are incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A continuous flow microfluidic system for continuous flow operation of a microfluidic chip, comprising the following (1) to (4), wherein a pulsation rate of a continuous flow formed by the system is 5% or less:
(1) a first continuous flow pump that continuously supplies a first fluid from a first reservoir;
(2) a second continuous flow pump that continuously supplies a second fluid from a second reservoir;
(3) a microfluidic device including a microfluidic chip having the following flow paths (a) to (c):
(a) a first supply flow path through which the first fluid flows;
(b) a second supply flow path through which the second fluid flows; and
(c) a mixing/diluting flow path that is provided on a downstream side of a junction where the first supply flow path and the second supply flow path join with each other with a certain length and through which a mixed fluid in which the first fluid and the second fluid are mixed flows; and
(4) a discharge flow path through which the mixed fluid discharged from the microfluidic device flows.

2. The continuous flow microfluidic system according to claim 1, comprising a diluting portion including: a third continuous flow pump that continuously supplies a diluent solution from a third reservoir; and a diluting flow path that supplies the diluent solution discharged from the third continuous flow pump to a downstream side of the microfluidic device of the system to mix the diluent solution with the mixed fluid.

3. The continuous flow microfluidic system according to claim 1, comprising a waste collection flow path branched from the discharge flow path via a waste valve.

4. The continuous flow microfluidic system according to claim 1, which has a throughput of at least 3 L/h or more per the mixing/diluting flow path.

5. The continuous flow microfluidic system according to claim 1, wherein at least a part of the mixing/diluting flow path includes a bent flow path portion formed by a plurality of structural elements installed in the flow path, and when an axial direction of the mixing/diluting flow path is an X direction, a width direction of the mixing/diluting flow path orthogonal to the X direction is a Y direction, and a width of the mixing/diluting flow path on an upstream side of the bent flow path portion in the Y direction is [y0], the structural elements arranged to protrude from both side walls facing each other along the Y direction in the mixing/diluting flow path toward an inside of the flow path are installed alternately at predetermined intervals along the X direction, and a protrusion width of the structural elements in the Y direction is ½ [y0] or more and less than 1 [y0].

6. The continuous flow microfluidic system according to claim 1, wherein the microfluidic chip is formed of synthetic quartz glass.

7. The continuous flow microfluidic system according to claim 1, wherein the microfluidic device includes a chip holder and connectors,
the chip holder includes a cover and a base that are in contact with a surface of the microfluidic chip, and a fixture that connects and fixes the cover and the base, the microfluidic chip is arranged between the cover and the base, the cover and the base are connected and fixed with the fixture, and the microfluidic chip is fixed in a state of being in close contact with the cover and the base, each connector penetrates at least one of the cover and the base, one end side is connected to an opening provided at each of an upstream end of the first supply flow path, an upstream end of the second supply flow path, and a downstream end of the mixing/diluting flow path of the microfluidic chip, and an other end side forms a supply port of the first fluid or the second fluid or a discharge port of the mixed fluid, and
flatness of a surface of the microfluidic chip in contact with the cover and flatness of a surface of the microfluidic chip in contact with the base are both 50 μm or less, and planarity of a surface of the cover in contact with the microfluidic chip and planarity of a surface of the base in contact with the microfluidic chip are both 50 μm or less.

8. The continuous flow microfluidic system according to claim 1, which is used for producing self-assembled substance particles, wherein in the mixing/diluting flow path, a self-assembled substance-containing solution supplied from one of the first supply flow path and the second supply flow path is diluted with a dilution medium supplied from the other flow path to form self-assembled substance particles.

9. A production method for producing self-assembled substance particles, comprising a step of diluting a self-assembled substance-containing solution with a dilution medium to obtain liquid containing self-assembled substance particles, wherein the step is performed using the continuous flow microfluidic system according to claim 8.

10. The production method according to claim 9, wherein the self-assembled substance is a lipid or an amphipathic substance.

11. The production method according to claim 9, wherein the dilution medium is selected from an aqueous solution, a buffer solution, a nucleic acid-containing aqueous solution, a protein-containing aqueous solution, a peptide-containing aqueous solution, an adjuvant-containing aqueous solution, and a mixed solution thereof.
